(19) United States
(12) Patent Application Publication
(10) Pub. No.: US 2013/0265960 A1
(43) Pub. Date: Oct. 10, 2013

(54) METHOD AND APPARATUS FOR MODIFYING CHANNEL QUALITY INDICATION

(71) Applicants: Gang Wang, Beijing (CN); Yu Zhang, Beijing (CN); Zhennian Sun, Beijing (CN); Ming Lei, Beijing (CN)

(72) Inventors: Gang Wang, Beijing (CN); Yu Zhang, Beijing (CN); Zhennian Sun, Beijing (CN); Ming Lei, Beijing (CN)

(73) Assignee: NEC (CHINA) CO., LTD., Beijing (CN)

(21) Appl. No.: 13/879,341

(22) PCT Filed: Feb. 28, 2011
(86) PCT No.: PCT/CN11/71408

§ 371 Date: Apr. 12, 2013

(51) Int. Cl. H04B 7/06

(52) U.S. Cl. CPC H04B 7/0632
USPC 370/329; 370/328

(57) ABSTRACT

The present invention discloses a method and an apparatus for modifying a channel quality indication (CQI). This method may comprise: calculating a scaling factor for the channel quality indication based on uplink channel information and an antenna virtualization pre-coding scheme; and modifying the channel quality indication reported by user equipment by using the scaling factor. According to the technical solutions of the present invention, the antenna virtualization factor is considered in performing CQI modification and. Thus, this solution can overcome the problem of CQI mismatch, enhance the completeness and accuracy of CQI feedback, and improve the cell throughput performance and frequency utilization.

### FIELD OF THE INVENTION

The present invention relates to the field of mobile communication technology, and more particularly, to a method and an apparatus for modifying channel quality indication.

### BACKGROUND OF THE INVENTION

With the constant increase of mobile data services and emergence of new-type applications such as multimedia online game (MMOG), mobile TV, Web2.0, and stream media, the 3rd Generation Partnership Project (3GPP) organization has developed long-term evolution (LTE) specifications. 3GPP LTE, which is known as an evolution standard of the Global System for Mobile Communications/High Speed Packet Access (GSM/HSPA) technology that has achieved a great success, aims at creating a new series of specifications for the new evolving radio-access technology, so as to go on improving the cellular communication system performance, such as achieving a higher throughput and a lower packet transmission latency.

An LTE system can operate both in Frequency Division Duplex (FDD) mode and Time Division Duplex (TDD) mode. In the FDD mode, the uplink and downlink employ a pair of frequency spectrums for data transmission; while in the TDD mode, the uplink and downlink channels share the same frequency, but occupy different time slots. Therefore, the TDD system has channel reciprocity, by which the downlink wireless channel information could be obtained with the knowledge get from the uplink channel.

In a downlink operation of the TDD system, a user equipment UE is responsible for measuring the downlink channel and feeding information back to a base station device (eNB) for using by the eNB to perform scheduling and allocating operations. FIG. 1 schematically illustrates a block diagram for communications between eNB and UEs according to existing specifications. As illustrated in FIG. 1, to enable the UE to fully appreciate the downlink channel, eNB transmits a cell specific reference signal (CRS) to the UE in some certain time and frequency combination resources (also called resource element RE) in the LTE system. The CRS is a pre-defined signal, pre-known to both the transmitter and the receiver; therefore, the UE can derive the downlink channel condition based on the received CRS. The CRS is not pre-coded and is transmitted over the entire system bandwidth of a cell. A data receiving unit 101 in the UE is for receiving CRS/data. A feedback calculation unit 102 is for calculating a feedback parameter, for example calculating a channel quality indication (CQI) based on the CRS. The feedback calculating unit 102 in the UE can calculate the CQI based on the channel information on some valid sub-frames, so as to obtain the CQI based on a PDSCH transmission scheme configured by a transmission mode (TM). For example, for mode 7 and mode 8 (hereinafter referred to as TM7 and TM8, respectively), if the number of PBCH antenna ports is one, then a single port solution is adopted; while if the number of PBCH antenna ports is more than one, then transmit diversity is adopted. A feedback transmission unit 103 is for transmitting to the eNB feedback information such as CQI, Pre-coding Matrix Information (PMI), Rank Indication (RI), etc. At the eNB, a scheduler unit 111 performs resource scheduling to each UE based on feedback information from the UE. Then, an allocation processing unit 112 performs channel resource allocation processing.

Besides, thanks to the channel reciprocity feature in the TDD system, it is possible for LTE to enable better performance for radio resource control and advanced antenna techniques. For example, in coverage limited areas like rural area, beamforming is one of the most effective ways to provide coverage extension and to reduce the number of cell sites. The enhanced signal strength to noise ratio allows more margins for UE decoding the data symbols, and the more efficient Modulation Coding and Scheme (MCS) could be used to improve the spectrum efficiency. Further, in LTE release 8 and 9, single layer and dual layer beamforming on antenna port 5 and 7, 8 are already supported.

FIG. 2 schematically illustrates a flowchart of beamforming operation according to existing specifications. As illustrated in FIG. 2, this operation mainly comprises beamforming weight and CQI acquirement process and beamforming and link adaptation process, which are illustrated by two big dashed blocks. As illustrated in the figure, at step S201, the UE transmits an uplink channel sounding reference signal (SRS) to the eNB. At step S202, the eNB obtains the channel state indication (CSI) information through the SRS information and calculates a beamforming weight based on the CSI information. At step S203, the UE obtains the CQI based on the CRS from the eNB and transmits the CQI to the eNB. At step S204, the eNB obtains the CQI. Then, at step S205, the eNB performs pre-coding and link adaptive operation based on the calculated beamforming weight and CQI indication. After that, at step S206, pre-coded data symbols and a UE specific reference signal (UE-RS) that is pre-coded in the same manner as those data symbols are transmitted to the UE. At step S207, after receiving the UE-RS, the UE performs demodulation on the received data symbol based on the received UE-RS.

The beamforming operation is based on non-codebook pre-coding and relies on the UE-RS for data demodulation. Because the UE-RS symbol is pre-coded with the same pre-coding matrix as the downlink data symbols, the UE can estimate out an effective channel. However, the UE-RS is transmitted only when the UE is being scheduled, and is therefore only transmitted over the frequency resource assignment of data transmission and can not be used as the resource for measuring the CQI by the UE. Therefore, it is based on the CRS assuming transmit diversity that the UE calculates the CQI, while the downlink data symbols are transmitted based on transmit beamforming. This brings about a CQI difference between the transmit diversity and the transmit beamforming, or CQI difference between the CRS and the UE-RS, which means loss of gain that would have been brought by the beamforming, and this loss of gain directly leads to the throughput performance degradation. Therefore, it needs a solution for modifying the CQI.

To compensate for the CQI difference between the transmit diversity and the transmit beamforming, two simple CQI modification algorithms are disclosed in Chinese patent publication NO. CN101741508A and the PCT patent application publication No. WO2010/066131 filed by Applicant “ZTE Corporation.” Hereinafter, technical solutions in these two patents will be briefly described with reference to FIGS. 3a-3b and FIGS. 4a-4b. FIGS. 3a-3b schematically illustrate a communication block diagram and a process flowchart according to the technical solution of the Chinese patent publication CN101741508A; and FIGS. 4a and 4b schematically illustrate a communication block diagram and a process flowchart according to the technical solution of WO2010/066131A1.

With reference to FIG. 3a, compared with the structure of FIG. 1, this technical solution incorporates a CQI modification unit 113 at the eNB end, for performing CQI modification. As illustrated in FIG. 3b, operations of UE is similar to the prior art. First, at step S301, the feedback calculating unit 102 calculates a CQI based on the CRS received by the data receiving unit 101, and at step S302, the calculated CQI is reported to the eNB through the feedback transmission unit 113. Then at step S303, the scheduler unit 111 performs resource scheduling to each UE based on the UE reported CQI. If one UE is scheduled, then at step S304, the CQI of the UE is modified by adding a fixed amount corresponding to a beamforming gain; this fixed amount is specifically a 10 log₁₀ MdB, wherein a is a constant with a value ranging form 0.6 to 0.8, and M, also as a constant, is the number of transmit antennas. After that, at step S305, a modulation and coding scheme (MCS) of the UE can be updated based on the new CQI.

Next, referring to FIG. 4a, different from FIG. 3a, the technical solution as illustrated in this figure is to incorporate an CQI adjusting unit 104 into the UE, namely in each UE, so as to perform CQI modification. As illustrated in FIG. 4b, first, at step S401, the feedback calculating unit 103 calculates an SINR based on the CRS received from the data receiving unit 101; at step S402, the CQI modification unit modifies the SINR of the UE by adding a 10 log₁₀ MdB, where a is a constant with a value ranging form 0.6 to 0.8, and M is the number of transmit antennas. At step S403, CQI is selected based on the modified SINR; then at step S404, the feedback transmission unit 103 reports the CQI to the eNB. The operations of eNB are substantially identical to the prior art as illustrated in FIG. 1.

From the above, it is seen that the in the above two patent literatures, a fixed CQI offset value a 10 log₁₀ MdB corresponding to the beamforming gain is added to a UE reported or measured CQI, to compensate for the CQI difference between the transmit diversity and the transmit beamforming. However, both technical solutions are based on a single-antenna port solution, which are inapplicable to a case of more than one antenna ports. Further, the prior art also has an outer ring link adaptive solution; however, this modification is implemented by adding or decreasing CQI based on an ACK/NACK feedback regarding codebook selection; it is not a direct modification manner and has feedback latency; besides, it is quite time-consuming, which would also deteriorate system performances.

Therefore, there is urgently needed a new CQI modification scheme in the art.

### SUMMARY OF THE INVENTION

In view of the above, the present invention provides a new solution for modifying channel quality indication so as to solve or at least partially mitigate overcome at least a part of defects in the prior art.

According to an aspect of the present invention, there is provided a method for modifying channel quality indication. This method may comprise: calculating a scaling factor for the channel quality indication based on uplink channel information and antenna virtualization pre-coding scheme; and modifying the channel quality indication reported by a user equipment using the scaling factor.

According to one preferred embodiment of the present invention, scheduling user equipments is performed based on the modified channel quality indication.

According to another preferred embodiment, the calculating a scaling factor for the channel quality indication comprises: estimating a beamforming gain for downlink parallel transmission channel through on uplink channel information; estimating equivalent downlink channel information in case of using antenna virtualization based on the uplink channel information and the antenna virtualization pre-coding scheme; and determining the scaling factor for the channel quality indication based on the beamforming gain and the equivalent downlink channel information.

According to a further embodiment of the present invention, a scaling factor is calculated for each sub-carrier, and a channel quality indication is modified for each sub-carrier by using the scaling factor for each sub-carrier; additionally, this method may further comprise: converting the modified channel quality indication on each sub-carrier into a channel quality indication for a wideband through physical layer extraction.

According to a yet further embodiment of the present invention, the scaling factor G(n) for each sub-carrier may be expressed as:

$$G ( n ) = \frac{{δ}^{2}}{{\sum }_{t = 0}^{1} {\sum }_{r = 0}^{{N}_{R} - 1} \vert {H}_{t , r}^{( 0 )} ( n ) {\vert}^{2}}$$

where δ denotes a main eigen value of the downlink channel matrix as estimated through the uplink channel information; H_{t,r}⁽⁰⁾(n) denotes an equivalent downlink channel matrix for the sub-carrier n in case of using antenna virtualization, where t denotes a transmit antenna port index, n denotes a sub-carrier index, r denotes a receiving antenna index, and N_{R} denotes the number of receiving antennas.

According to another aspect of the present invention, there is further provided an apparatus for modifying channel quality indication. This apparatus may comprise: scaling factor calculation means configured to calculate a scaling factor for the channel quality indication based on uplink channel information and antenna virtualization pre-coding scheme; and indication modification means configured to modify the channel quality indication reported by user equipment using the scaling factor.

According to a further aspect of the present invention, a base station is further provided; this base station comprises the apparatus provided according to the present invention.

According to the technical solutions of the present invention, it uses a scaling factor considering the antenna virtualization technology for modifying the CQI, therefore the CQI mismatch problem in case of using antenna virtualization technology can be overcome, completeness and accuracy of CQI feedback is improved, and cell throughput performance and frequency utilization is enhanced.

### BRIEF DESCRIPTION OF THE DRAWINGS

The above and other features of the present invention will become more apparent through detailed description of the embodiments taken in conjunction with the accompanying drawings in which reference signs indicate like or similar components. In the accompanying drawings,

FIG. 1 schematically illustrates a block diagram of communication between eNB and UEs according to existing specifications;

FIG. 2 schematically illustrates a flowchart of beamforming operation according to existing specifications;

FIGS. 3a and 3b illustrate a communication block diagram and a method flowchart of a CQI modification solution according to the prior art;

FIGS. 4a and 4b illustrate a communication block diagram and a method flowchart of another CQI modification solution according to the prior art;

FIG. 5 schematically illustrates a flow chart of a method for modifying the CQI according to an embodiment of the present invention;

FIG. 6 schematically illustrates a diagram of a typical transmission antenna configuration at eNB in the TD-LTE system;

FIG. 7 schematically illustrates a flow chart of a method for calculating a CQI scaling factor according to an embodiment of the present invention;

FIG. 8 schematically illustrates an exemplary flowchart of CQI modification according to a specific implementation of the present invention;

FIG. 9 schematically illustrates a block diagram of an apparatus for modifying CQI according to an embodiment of the present invention;

FIG. 10 schematically illustrates a block diagram of communication between eNB and UEs according to an embodiment of the present invention.

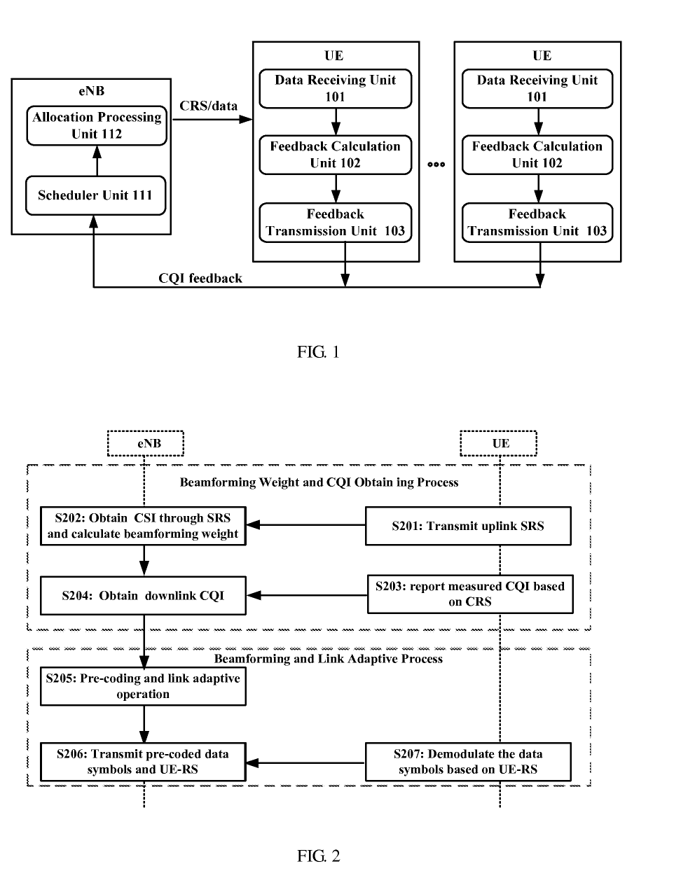

### DETAILED DESCRIPTION OF PREFERRED EMBODIMENTS

Hereinafter, reference will be made to the companying drawings to describe a method and an apparatus for modifying CQI as provided by the present invention in detail through preferred embodiments. It should be understood that these embodiments are presented only to enable those skilled in the art to better understand and implement the present invention, not intend for limiting the scope of the present invention in any manner.

It should be first noted that in this invention is illustrated particular sequences for performing the steps of the methods. However, these methods are not necessarily performed strictly according to the illustrated sequences, and they can be performed in reverse sequence or simultaneously based on natures of respective method steps.

Herein, the terms “channel quality indication CQI” and “Signal to Interference plus Noise Ratio (SINR)” are used. In view of the fact that SINR and CQI have a mapping relationship therebetween, the SINR and CQI have an equivalent meaning in this invention. Moreover, “SINR” and “CQI” are always exchangeable herein. Further, in this invention, for example, if H (n) is used to denote a downlink channel matrix for the sub-carrier n and H is used, in some cases, to denote the matrix for the sake of simplicity, but it does not mean that H does not represent the channel matrix for sub-carrier n, unless otherwise specified explicitly. For example, if it may be determined that this H denotes a channel matrix for a sub-carrier based on the knowledge of those skilled in the art and/or expressions illustrated herein, then H may still denote a link matrix for the sub-carrier. Additionally, given that M denotes a certain matrix here, then M^{T} denotes transpose of the matrix M, M^{H} denotes the Hermite transpose of the matrix, also called as conjugate transpose, and M* denotes a complex conjugate of this matrix.

Hereinafter, FIG. 5 will be referenced to describe a flowchart of a method for modifying CQI according to an embodiment of the present invention.

As illustrated in FIG. 5, first at step S501, a scaling factor for a channel quality indication can be calculated based on uplink channel information and antenna virtualization pre-coding scheme.

Hereinafter, it will be first described in detail how to determine the scaling factor.

It is known that in the TDD system, both uplink and downlink use a same frequency resource to transmit data; therefore based on the reciprocity between the uplink and the downlink, downlink channel information can be estimated from on the uplink channel information. As an example, the downlink channel matrix H(n) for each sub-carrier n may be estimated based on the uplink SRS; this matrix is a m×k matrix, where m denotes the number of physical transmission antennas, and k denotes the number of physical receive antennas.

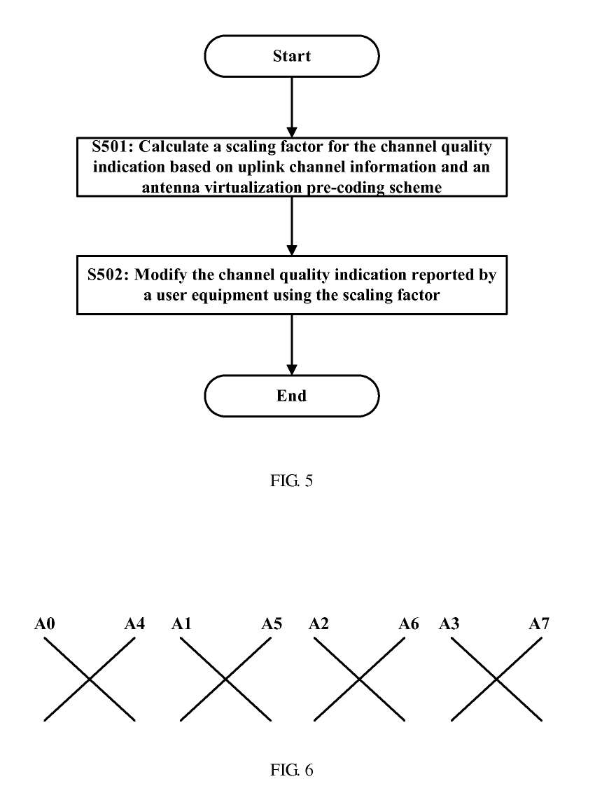

It is known that in current LTE release 8 and release 9, the maximum number of downlink antenna ports is 4. Therefore, if the eNB has more than 4 transmission antenna, antenna virtualization technology would be utilized to map the physical antennas to the available antenna ports. FIG. 6 schematically illustrates a typical transmission antenna configuration at eNB in the TD-LTE system. As illustrated in FIG. 6, the eNB has 8 cross-polarized physical antennas A0 to A7, wherein the number of antenna ports is 2, and the physical antennas are divided into two groups {A0, A1, A2, A3} and {A4, A5, A6, A7}. Each antenna group is pre-coded by a pre-coding vector w. An example of the pre-coding vector, which has been openly used in our days, is give as below.

w=(1/sqrt(8))*[−0.2421+0.3241i, −0.4938+0.8696i, −0.4938+0.8696i, 0.2603−0.5622i]^{T}

However, it should be noted that, the present invention is not limited thereto. This pre-coding vector will vary with various factors such as different technical solutions, versions of a technical solution, and different solution providers.

Therefore, an equivalent downlink matrix in case of using antenna virtualization may be further estimated based on an antenna virtualization coding scheme. In an embodiment, the equivalent downlink matrix can be estimated based on the downlink channel matrix H(n) that is estimated based on the uplink channel information hereinbefore and the antenna virtualization coding scheme; this equivalent downlink matrix H_{t,r}⁽⁰⁾(n) may be estimated through for example the following expression:

H_{t,r}⁽⁰⁾(n)=W^{T}*H(n) (Expression 1)

Wherein, H_{t,r}^{(j)}(n) denotes a downlink channel matrix between the t-th transmit and the r-th receive antenna in j-th cell, j=0 denotes a serving cell, W denotes an antenna virtualization coding matrix to be used in downlink data transmission, which is a block diagonal matrix and can be expressed as [w, 0; 0, w], where the w denotes a CRS pre-coding vector, namely the pre-coding vector as described hereinabove.

Based on the signal power and the UE reported CQI, a noise plus interference for the UE can be estimated. For example, the noise plus interference P_{N+I}(n) for UE on the sub-carrier n may be estimated as follows:

$${P}_{N + 1} ( n ) = \frac{{P}_{s} ( n )}{{γ}_{i}^{0} ( n )} \qquad ( Expression 2 )$$

wherein, P_{S}(n) denotes the signal power on the sub-carrier n; and γᵢ⁰(n) denotes the SINR (CQI) for the sub-carrier n, which may be derived based on SINR (CQI) γᵢ⁰ reported by the UEᵢ for the entire wideband.

Without considering the transmit power, Expression 2 may be further simplified as below:

$${P}_{N + 1} ( n ) = \frac{{\sum }_{t = 0}^{1} {\sum }_{r = 0}^{{N}_{R} - 1} \vert {H}_{t , r}^{( 0 )} ( n ) {\vert}^{2} )}{{γ}_{i}^{0} ( n )} \qquad ( Expression 3 )$$

wherein, N_{R} denotes the number of receive antennas of the UE. Additionally, in the case of adopting the beamforming technology, the SINR (CQI) γᵢ¹ of the user equipment UEᵢ on the carrier n may be denoted as below:

$${γ}_{i}^{1} ( n ) = \frac{{δ}^{2}}{{P}_{N + 1} ( n )} \qquad ( Expression 4 )$$

wherein δ denotes the beamforming gain of the downlink parallel transmission channel, which may be estimated through the uplink channel information; P_{N+I}(n) denotes a noise plus interference of the user equipment on the sub-carrier n. It should be noted that, the beamforming gain δ of the downlink parallel transmission channel may be based on a sub-carrier or sub-band, or based on the entire frequency band.

The following expression can be derived by introducing P_{N+I}(n) in Expression 3 into Expression 4:

$${γ}_{i}^{1} ( n ) = \frac{{δ}^{2}}{{\sum }_{t = 0}^{1} {\sum }_{r = 0}^{{N}_{R} - 1} \vert {H}_{t , r}^{( 0 )} ( n ) {\vert}^{2}} {γ}_{i}^{0} = G {γ}_{i}^{0} \qquad ( Expression 5 )$$

wherein G denotes the CQI scaling factor, which is expressed as below:

$$G = \frac{{δ}^{2}}{{\sum }_{t = 0}^{1} {\sum }_{r = 0}^{{N}_{R} - 1} \vert {H}_{t , r}^{( 0 )} ( n ) {\vert}^{2}} \qquad ( Expression 6 )$$

Through the process as provided above, the relationship between the SINR (CQI) in case of using beamforming technology and the user reported SINR (CQI) is obtained. Therefore, the SINR (CQI) in case of using beamforming technology can be estimated by obtaining the scaling factor G and based on the user reported SINR (CQI).

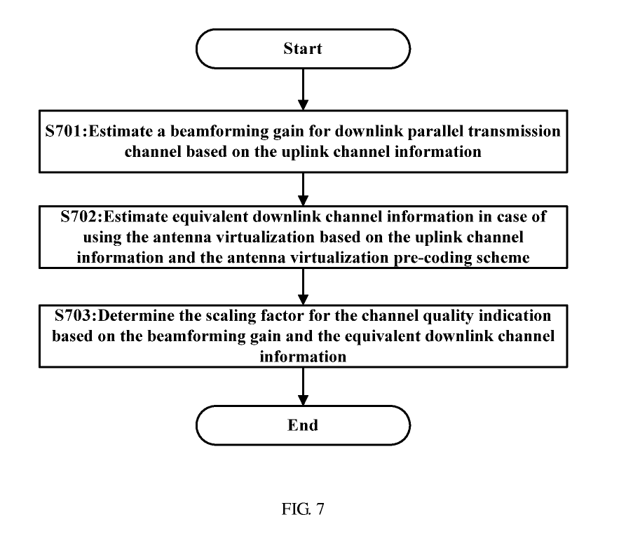

Hereinafter, reference will be made to FIG. 7 to describe an exemplary flowchart for calculating the CQI scaling factor according to an embodiment of the present invention.

As illustrated in FIG. 7, first, the beamforming gain for the downlink parallel transmission channel is estimated through the uplink channel information.

As described previously, based on the uplink channel information, for example SRS, the downlink channel information H(n) can be estimated, and the beamforming gain of the downlink parallel transmission channel can be obtained through performing eigen value extraction to the H(n).

In an embodiment of the present invention, the eigen value may be extracted by a singular value decomposition (SVD) method.

According to this embodiment, the m×k channel matrix H (n) may be expressed as

H=UΛV^{H} (Expression 7)

wherein U is a m×m matrix, V is a k×k matrix, and Λ is a m×k matrix. Both U and V are unitary matrices, i.e., respective lines of the matrix have a unit length and are mutually orthogonal, therefore UÛ{T}=I and VV̂{T}=I. Λ is a diagonal matrix, respective diagonal elements of which are non-negative and are sorted so that the large elements lies in are in a front position. It may be expressed as:

Λ=diag[δ₁, δ₂, . . . ] (Expression 8)

wherein δ₁, δ₂, . . . are singular values of this matrix, which correspond to beamforming gains, where δ₁ is the maximum singular value (also called as a principal eigen value) corresponding to the maximum beamforming gain, while the corresponding singular vector is the beamforming weight.

Thus, it is quite clear that matrix Λ can be derived through matrix transformation based on the Expression 7, and in turn each singular value corresponding to the beamforming gain is further obtained.

In addition, in another embodiment of the present invention, the beamforming gain may be obtained using eigen value decomposition (EVD).

According to this embodiment, the relationship between the channel matrix H(n) and Λ may be expressed as:

EVD(H^{H}H)=VΛ²V^{H} (Expression 9)

wherein, similarly, V is a unitary matrix, VV̂{T}=I; and Λ is a real diagonal matrix comprising a plurality of singular values, which may be expressed as:

Λ=diag[δ₁, δ₂, . . . ] (Expression 10)

wherein δ₁, δ₂, . . . are eigen values of this matrix, corresponding to beamforming gains, where δ₁ is the maximum eigen value corresponding to the maximum beamforming gain, while the feature vector is the beamforming weight. Besides, the eigen value decomposition process comprises a sort process for finding the maximum eigen value and the corresponding feature vector.

Therefore, it is very clear that matrix Λ may be derived through matrix transformation according to the Expression 9, and further each eigen value corresponding to the beamforming gain may be obtained.

In an embodiment of the present invention, the maximum eigen value is used as a reflection on the beamforming gain of the uplink parallel transmission channel, i.e., this principal eigen value is used to determine the CQI scaling factor. However, it is a preferred embodiment, and the present invention is not limited thereto. For example, an eigen value derived by integrating a plurality of or all eigen values may also be used as the beamforming factor of the downlink channel.

In addition, according to this invention, the principal eigen value of the downlink channel matrix may be based on a sub-carrier or a sub-band, or the entire frequency band.

Next, at step S702, equivalent downlink channel information in case that the antenna virtualization is adopted is estimated based on the uplink channel information and the antenna virtualization pre-coding scheme.

As previously mentioned, reciprocity exists between uplink channel and downlink channel in the TDD system. Thus, the downlink channel information, for example downlink channel matrix H (n) for each sub-carrier n, may be estimated based on the uplink channel information. In case of adopting beamforming, the equivalent downlink matrix H_{t,r}⁽⁰⁾(n) may then be estimated through the foregoing Expression 1.

Then, at step S703, the scaling factor for the channel quality indication is determined based on the beamforming gain and the equivalent downlink channel information.

Based on the beamforming gain δ and equivalent downlink matrix H_{t,r}⁽⁰⁾(n) as determined at step S701 and step S702, the CQI scaling factor G can be calculated according to the Expression 6.

Continuing to refer to FIG. 5, at step S502, the channel quality indication reported by the user equipment is modified with the scaling factor G.

The channel quality indication as reported by the user is calculated by the UE based on the CRS. At UE, in case that the number of antenna ports is more than one, the γᵢ⁰(n) for the sub-carrier n may be calculated as below:

$${γ}_{i}^{0} ( n ) = \frac{{P}_{s}}{{P}_{N} + {P}_{inter\_cell}} \\ wherein , \\ {P}_{S} = {P}_{tx}^{( 0 )} {P}_{loss}^{( 0 )} {σ}_{0}^{2} {\{ {\sum }_{t = 0}^{1} {\sum }_{r = 0}^{{N}_{R} - 1} \vert {H}_{t , r}^{( 0 )} ( n ) {\vert}^{2} \}}^{2} ; \\ {P}_{N} = \{ {\sum }_{t = 0}^{1} {\sum }_{r = 0}^{{N}_{R} - 1} \vert {H}_{t , r}^{( 0 )} ( n ) {\vert}^{2} \} {σ}^{2} ; \\ {P}_{inter\_cell} = {\sum }_{j = 1}^{{N}_{l}} {P}_{tx}^{( j )} {P}_{loss}^{( j )} {σ}_{j}^{2} \{ \vert {\sum }_{r = 0}^{{N}_{R} - 1} {{H}_{0 , r}^{( 0 )} ( n )}^{*} {H}_{0 , r}^{( j )} ( n ) {\vert}^{2} + \vert {\sum }_{r = 0}^{{N}_{R} - 1} {H}_{1 , r}^{( 0 )} ( n ) {{H}_{0 , r}^{( j )} ( n )}^{*} {\vert}^{2} \} ; \qquad ( Expression 11 )$$

Pₜₓ^{(j)}: total transmit power from j-th eNB, j=0 means a serving cell;
Pₗₒₛₛ^{(j)}: Passloss+shadowing+antenna gain/loss+cable loss from j-th eNB;
σⱼ²: Variance of symbols;
σ²: Variance of additive white Gauss noise (AWGN);
H_{t,r}^{(j)}(n): Channel matrix between the t-th transmit and the r-th receive antenna.

For PUCCH mode 1-0, information extraction will be performed on the calculated γᵢ⁰(n), for example by the physical layer abstraction method; and the wideband SINR γᵢ⁰ for the entire bandwidth is calculated and derived based on γᵢ⁰(n) for each sub-carrier.

The physical-layer abstraction method is a technology for predicting transient link performance of an orthogonal frequency division multiplexing (OFDM) system. To make the encoded block error rate (BLER) for coding the transmit blocks is lower than the threshold (generally 0.1), SINR associated with each sub-carrier is generally mapped into one SINR (wideband) or a limited few of SINRs (sub-band). For the purpose of exemplifying, an example of physical layer abstraction method will be provided hereinafter. However, it should be noted that the present invention is not limited thereto, which may be implemented by any other existing or future developed suitable abstraction technology.

Exponential effective SINR mapping (EESM) is a commonly used physical layer abstraction method, which may be expressed through the following expression:

$${γ}_{i}^{0} = - β ln ( \frac{1}{N} {\sum }_{n = 1}^{N} exp ( - \frac{{γ}_{i}^{0} ( n )}{β} ) ) \qquad ( Expression 12 )$$

wherein, β is an optimization/modification factor dependent on the MCS and encoded block length.

Therefore, the wideband SINR γᵢ⁰ may be derived through Expression 12. Next, the wideband SINR γᵢ⁰ is mapped into a wideband CQI and reports it to the eNB.

The eNB, upon receiving the wideband CQI reported by the user equipment, may obtain the corresponding SINR γᵢ⁰(n) based on the mapping relationship.

Based on γᵢ⁰(n) and the scaling factor G as derived at step S501, the modified γᵢ⁰(n) may be obtained based on for example the above-mentioned Expression 5. The γᵢ⁰(n) is a modified SINR for each sub-carrier. In order to obtain the wideband SINR for the entire bandwidth, it can be similarly based on the previous Expression 12 to determine the wideband SINR, thereby obtaining a matching wideband γᵢ¹.

After obtaining the wideband γᵢ¹, the wideband γᵢ¹ may be re-mapped to the corresponding CQI. After that, the resource is scheduled preferably based on the modified CQI, and corresponding allocation processing is performed when the UE is scheduled. However, it should be noted that it is a preferred technical solution. Actually, CQI modification may also be performed after scheduling; however, because the resource scheduling is not based on the modified CQI, it will have defect that the resource scheduling is not optimal.

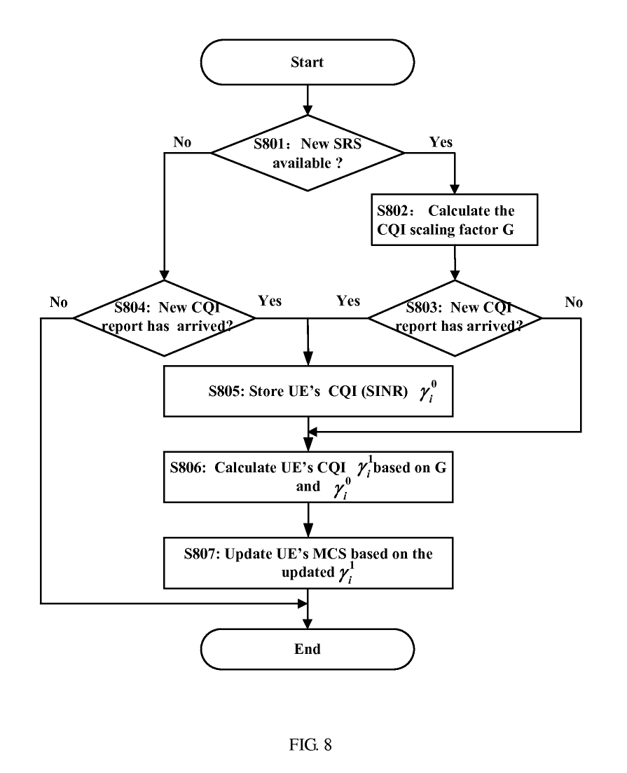

For the purpose of illustration, in FIG. 8 is shown a flowchart of CQI modification according to a specific implementation of the present invention. Hereinafter, FIG. 8 will be referenced to describe an exemplary specific implementation of the present invention.

As illustrated in FIG. 8, first, for example, at step S801, it is determined that whether a new SRS is available; if yes, then at step S802, the scaling factor G (as described with reference to step S501) is calculated, and the flow proceeds to step S803 to determine whether a new CQI report has arrived; if it is determined that no SRS is available yet at step S801, then the flow proceeds to step S804 to determine whether a new CQI report has arrived.

If is determined that a new CQI report is available at step S803 or S804, then the flow proceeds to step S805 to store the CQI (SINR) γᵢ⁰ for the user equipment in the eNB, and then the flow proceeds to step S806. Whereas if it is determined at step S803 that a new CQI report is unavailable, then the flow proceeds to step S806, and if it is determined that a new CQI report is unavailable at step S804, then this flow will proceed to the end step and end the method.

At step S806, the CQI γᵢ¹ of the UE is calculated based on the calculated CQI proportional factor and the stored latest γᵢ⁰ now, as described at step S502. Then, the method proceeds to step S807 and updates the MCS of the user equipment based on the updated γᵢ¹.

From the above description on the method of the present invention, it is seen that the technical solution of this invention adopts a direct modification manner, and the CQI modification factor determined thereby, i.e., the CQI scaling factor, considers the effect of adopting the antenna virtualization technology. Therefore, the modified CQI is well adapted to downlink data transmission assuming multi-port beamforming, particularly to the scenario in which the antenna virtualization technology is adopted. Accordingly, it can quickly and effectively eliminate or at least partially alleviate the problem of CQI mismatch in the prior art, thereby enhancing the cell throughput performance and frequency utilization.

Besides, the inventors carry out a system-level simulation for the CQI modification scheme as provided by the present invention and the schemes in the prior art as introduced in the Background of the Invention. The simulation results are shown in Tables 1 and 2.

TABLE 1
Simulation Results 1

| | Average Cell Spectral | 5% Cell Edge Spectral |
|---|---|---|
| Scheme | Efficiency (bits/s/Hz) | Efficiency (bits/s/Hz) |
| TM7 | 1.560 | 0.031 |
| TM7 + the scheme of this | 2.589 | 0.113 |
| invention | | |
| TM7 + existing scheme A | 1.930 | 0.048 |
| TM7 + existing scheme B | 2.287 | 0.081 |

TABLE 2
Simulation Results 2

| | Average Cell Spectral | 5% Cell Edge Spectral |
|---|---|---|
| Scheme | Efficiency (bits/s/Hz) | Efficiency (bits/s/Hz) |
| TM7 + OLLA | 2.053 | 0.061 |
| TM7 + then scheme of this | 2.630 | 0.100 |
| invention + OLLA | | |
| TM7 + scheme A + OLLA | 2.361 | 0.083 |
| TM7 + scheme B + OLLA | 2.413 | 0.102 |

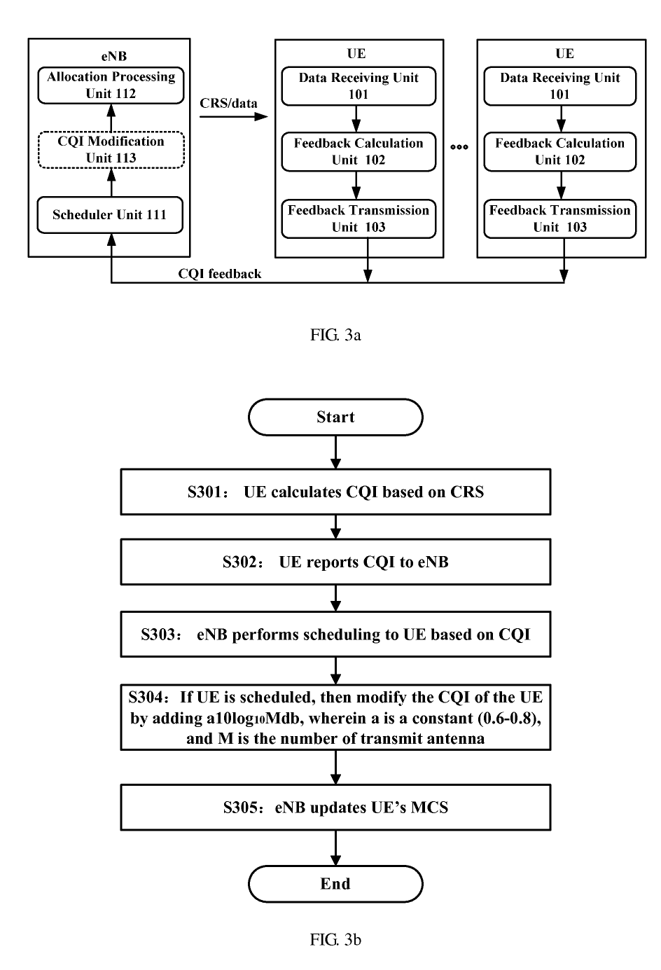

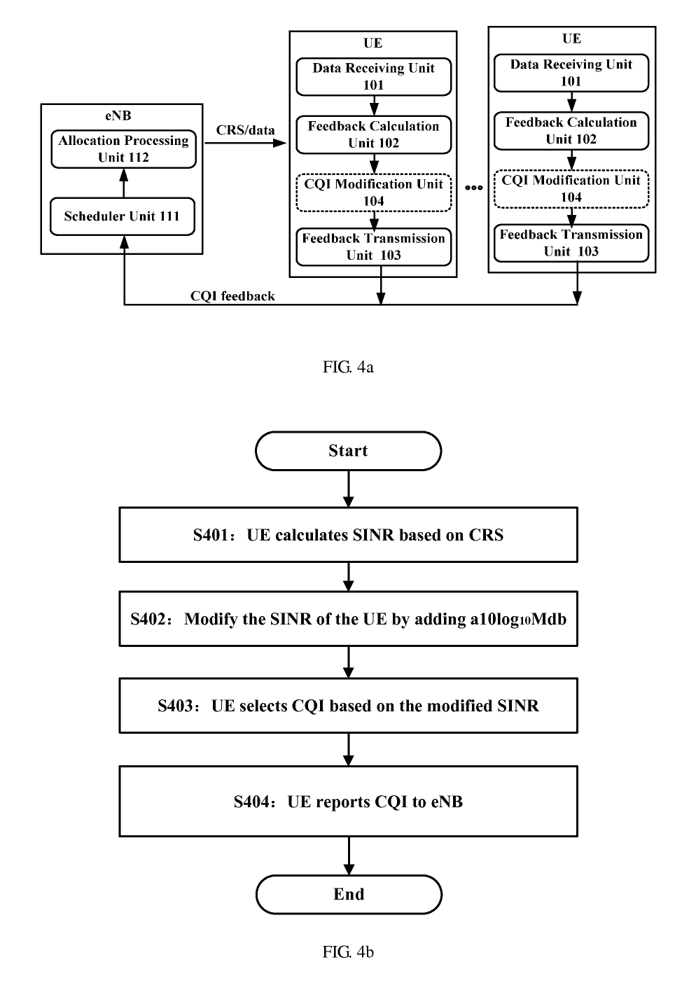

In Tables 1 and 2, TM7 refers to a scheme based on TM7, the scheme A refers to the technical solutions as presented in the Background of the Invention with reference to FIGS. 3A and 3B, the scheme B refers to the technical solution as presented in the Background of the Invention with reference to FIGS. 4A and 4B, and OLLA refers to the outer ring link adaptive scheme as mentioned in the Background of the Invention section.

From Table 1, it can be seen that the performance is significantly improved by using the present CQI modification scheme in TM7 mode compared to both the existing TM7 mode and the combinations of TM7 and each of the existing schemes A and B in the TM7 mode.

Besides, from Table 2 it can be seen that if the schemes as illustrated in Table 1 are used in combination with the OLLA, the performance after combination with the scheme of the present invention is improved little because the inventive scheme per se has achieved a significant performance improvement; on the contrary, the performance is greatly improved by combining the existing schemes as illustrated in Table 1 with the OLLA method.

Thus, both Table 1 and Table 2 show that the method of this invention can significantly improve system performance and would not consume much time as OLLA; therefore it is an effective CQI modification scheme over the prior art.

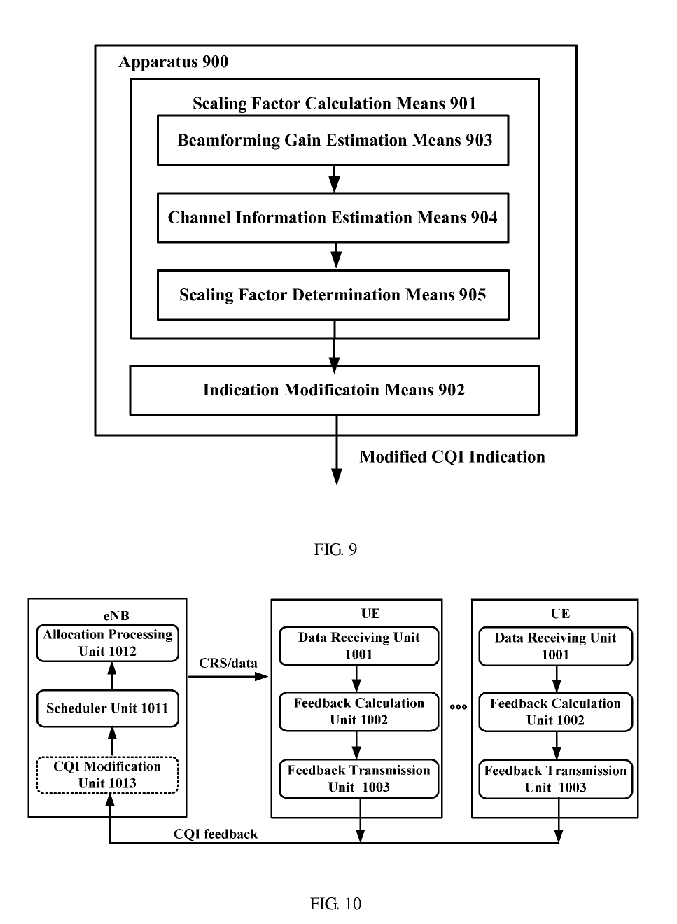

Additionally, the present invention further provides an apparatus for modifying CQI. Hereinafter, the apparatus will be described in detail with reference to FIG. 9 which illustrates an apparatus 900 for CQI modification according to an embodiment of the present invention.

As illustrated in FIG. 9, the apparatus 900 may comprise scaling factor calculation means 901 and indication modification means 902. The scaling factor calculation means 901 is configured to calculate a scaling factor for the channel quality indication based on uplink channel information and antenna virtualization pre-coding scheme; and the indication modification means 902 is configured to modify the channel quality indication reported by user equipment using the scaling factor.

According to a preferred embodiment of the present invention, scheduling the user equipment is performed based on the modified channel quality indication.

According to another preferred embodiment of the present invention, the scaling factor calculation means 901 can comprise: beamforming gain estimation means 903, channel information estimation means 904, and scaling factor determination means 905. The beamforming gain estimation means 903 is configured to estimate beamforming gain for downlink parallel transmission channel through the uplink channel information. The channel information estimation means 904 is configured to estimating equivalent downlink channel information in case of using antenna virtualization through the uplink channel information and the antenna virtualization pre-coding scheme. The scaling factor determination means 905 is configured to determine the scaling factor for the channel quality indication based on the beamforming gain and the equivalent downlink channel information.

According to an preferred embodiment of the present invention, the scaling factor calculation means 901 is configured to calculate a scaling factor for each sub-carrier, the channel quality indication modification means 902 is configured to modify the channel quality indication for each sub-carrier using the scaling factor for each sub-carrier and to convert the modified channel quality indication on each sub-carrier to a channel quality indication for a wideband.

According to one preferred embodiment of the present invention, the scaling factor G(n) for each sub-carrier can be expressed as:

$$G ( n ) = \frac{{δ}^{2}}{{\sum }_{t = 0}^{1} {\sum }_{r = 0}^{{N}_{R} - 1} \vert {H}_{t , r}^{( 0 )} ( n ) {\vert}^{2}}$$

where δ denotes a principal eigen value of a downlink channel matrix, which is estimated through the uplink channel information; H_{t,r}⁽⁰⁾(n) denotes an equivalent downlink channel matrix for the sub-carrier n in case of using antenna virtualization, t denotes a transmit antenna port index, n denotes a sub-carrier index, r denotes a receive antenna index, and N_{R} denotes the number of receive antennas. Besides, the principal eigen value δ can be based on a sub-carrier, a sub-band, or the entire band

It should be noted that operations of respective means as comprised in the apparatus 900 substantially correspond to respective method steps as previously described. Therefore, for detailed operations of respective means in the apparatus 900, reference can be made to the previous description on the method of the present invention with reference to FIGS. 5 to 7.

Additionally, the present invention further provides a base station comprising the apparatus for modifying a channel quality indication as provided by this invention, for example, the apparatus 900 as illustrated in FIG. 9.

FIG. 10 further schematically illustrates a block diagram of communication between eNB and UEs according to an embodiment of the present invention. As illustrated in FIG. 10, at UE, a data receiving unit 1001 receives CRS/data from eNB, and a feedback calculating unit 1002, as previously described with reference to Expressions 11 and 12, calculates the CQI based on the received CRS; the calculated CQI is transmitted to the eNB through a feedback transmission unit 1003.

At eNB, a CQI modification unit 1013 modifies the CQI in accordance with the solutions as previously described with reference to FIGS. 5 to 9. Then, a scheduler unit 1011 and an allocation processing unit 1012 perform resource scheduling and allocation processing based on the modified CQI.

By far, the present invention has been described with reference to the accompanying drawings through particular preferred embodiments. However, it should be noted that the present invention is not limited to the illustrated and provided particular embodiments, but various modification can made within the scope of the present invention. For example, during the process of deriving the scaling factor G, for the sake of simplicity, only equivalent downlink channel information is actually considered, while neglecting other factors such as transmit power, power loss, etc. However, the channel quality indication scaling factor can also be calculated with further consideration of one or more of these factors.

It should be noted that in the present invention, the calculated beamforming gain may be the beamforming gain for each sub-carrier n, or the beamforming gain of the entire wideband that is estimated from the beamforming gain for each sub-carrier n, or the beamforming gain of one of sub-carriers thereof.

Besides, in the present invention, the CQI scaling is calculated first for a sub-carrier, which, however, is a preferred embodiment; actually, it is also feasible to directly calculate the CQI scaling factor based on the entire bandwidth.

Further, in the embodiments according to the present invention, the technical solution according to the present invention is described mainly referring to LTE releases 8 and 9. However, it should be noted that the present invention is also applicable to any old LTE versions or future developed versions or other similar systems that have similar problems.

The technical solution of the present invention is described in combination with eNB. However, actually, besides eNB, the present invention is also applicable to any base station that has a similar problem.

In the present invention, it is described to perform CQI modification before performing scheduling. However, it is actually a preferred technical solution, and it is also feasible to perform CQI modification after scheduling.

Further, the embodiments of the present invention can be implemented in software, hardware or the combination thereof. The hardware part can be implemented by a special logic; the software part can be stored in a memory and executed by a proper instruction execution system such as a microprocessor or a dedicated designed hardware. Those normally skilled in the art may appreciate that the above method and system can be implemented with a computer-executable instructions and/or control codes contained in the processor, for example, such codes provided on a bearer medium such as a magnetic disk, CD, or DVD-ROM, or a programmable memory such as a read-only memory (firmware) or a data bearer such as an optical or electronic signal bearer. The apparatus and its components in the present embodiments may be implemented by hardware circuitry, for example a very large scale integrated circuit or gate array, a semiconductor such as logical chip or transistor, or a programmable hardware device such as a field-programmable gate array, or a programmable logical device, or implemented by software executed by various kinds of processors, or implemented by combination of the above hardware circuitry and software, for example by firmware.

Though the present invention has been depicted with reference to the currently considered embodiments, it should be appreciated that the present invention is not limited the disclosed embodiments. On the contrary, the present invention is intended to cover various modifications and equivalent arrangements falling within in the spirit and scope of the appended claims. The scope of the appended claims is accorded with broadest explanations and covers all such modifications and equivalent structures and functions.

1. A method for modifying a channel quality indication, comprising:
calculating a scaling factor for the channel quality indication based on uplink channel information and an antenna virtualization pre-coding scheme; and
modifying the channel quality indication reported by a user equipment using the scaling factor.

2. The method according to claim 1, wherein scheduling the user equipment is performed based on the modified channel quality indication.

3. The method according to claim 1, wherein the calculating the scaling factor for the channel quality indication comprises:
estimating a beamforming gain for downlink parallel transmission channel based on the uplink channel information;
estimating equivalent downlink channel information in case of using antenna virtualization, based on the uplink channel information and the antenna virtualization pre-coding scheme;
determining the scaling factor for the channel quality indication based on the beamforming gain and the equivalent downlink channel information.

4. The method according to claim 3, wherein the scaling factor is calculated for each sub-carrier, the channel quality indication is modified for each sub-carrier by using the scaling factor for each sub-carrier, and the method further comprising:
converting the modified channel quality indication on the each sub-carrier into a channel quality indication for a wideband by means of physical layer abstraction.

5. The method according to claim 4, wherein the scaling factor G(n) for each sub-carrier is expressed as:
$$G ( n ) = \frac{{δ}^{2}}{{\sum }_{t = 0}^{1} {\sum }_{r = 0}^{{N}_{R} - 1} \vert {H}_{t , r}^{( 0 )} ( n ) {\vert}^{2}}$$
wherein δ denotes a principal eigen value of a downlink channel matrix as estimated through the uplink channel information; H_{t,r}⁽⁰⁾(n) denotes an equivalent downlink channel matrix for the sub-carrier n in case of using antenna virtualization, t denotes a transmit antenna port index, n denotes a sub-carrier index, r denotes a receive antenna index, and N_{R} denotes the number of receive antennas.

6. An apparatus for modifying a channel quality indication, comprising:
scaling factor calculation means configured to calculate a scaling factor for a channel quality indication based on uplink channel information and antenna virtualization pre-coding scheme; and
indication modification means configured to modify the channel quality indication reported by a user equipment using the scaling factor.

7. The apparatus according to claim 6, wherein scheduling the user equipment is performed based on the modified channel quality indication.

8. The apparatus according to claim 6, wherein the scaling factor calculation means comprises:
beamforming gain estimation means configured to estimate a beamforming gain for downlink parallel transmission channel through the uplink channel information;
channel information estimation means configured to estimate equivalent downlink channel information in case of using antenna virtualization through the uplink channel information and the antenna virtualization pre-coding scheme; and
scaling factor determination means configured to determine the scaling factor for the channel quality indication based on the beamforming gain and the equivalent downlink channel information.

9. The apparatus according to claim 8, wherein the scaling factor calculation means is configured to calculate a scaling factor for each sub-carrier, the channel quality indication modification means is configured to modify the channel quality indication for each sub-carrier using the scaling factor for each sub-carrier and to convert the modified channel quality indication on each sub-carrier to a channel quality indication for a wideband.

10. The apparatus according to claim 9, wherein the scaling factor G(n) for each sub-carrier is expressed as:
$$G ( n ) = \frac{{δ}^{2}}{{\sum }_{t = 0}^{1} {\sum }_{r = 0}^{{N}_{R} - 1} \vert {H}_{t , r}^{( 0 )} ( n ) {\vert}^{2}}$$
where δ denotes a principal eigen value of a downlink channel matrix as estimated through the uplink channel information, H_{t,r}⁽⁰⁾(n) denotes an equivalent downlink channel matrix for the sub-carrier n in case of using antenna virtualization, t denotes a transmit antenna port index, n denotes a sub-carrier index, r denotes a receive antenna index, and NR denotes the number of receive antennas.

11. A base station, comprising the apparatus for modifying a channel quality indication according to claim 6.
